(19) United States
(12) Patent Application Publication
(10) Pub. No.: US 2013/0219054 A1
(43) Pub. Date: Aug. 22, 2013

(54) WORKLOAD MANAGEMENT IN HETEROGENEOUS ENVIRONMENTS

(71) Applicant: INTERNATIONAL BUSINESS MACHINES CORPORATION, (US)

(72) Inventors: Khirallah Birkler, Bad Saulgau (DE); Boris Feist, Ehningen (DE); Martin Oberhofer, Bondorf (DE); Torsten Wilms, Altdorf (DE)

(73) Assignee: INTERNATIONAL BUSINESS MACHINES CORPORATION, Armonk, NY (US)

(21) Appl. No.: 13/844,120

(22) Filed: Mar. 15, 2013

Related U.S. Application Data
(63) Continuation of application No. 13/235,303, filed on Sep. 16, 2011.

(30) Foreign Application Priority Data
Nov. 23, 2010 (EP) 10192196.3

(51) Int. Cl. H04L 12/26

(52) U.S. Cl. CPC H04L 43/08
USPC 709/224

(57) ABSTRACT

A system for managing a workload in a heterogeneous environment comprising at least one application, an interoperability layer for inter-application communication, and at least one adapter for connecting the at least one application to the interoperability layer, is disclosed. Such a system includes a self-adapting application connector management component which includes the following: a monitoring component for monitoring the performance and workload characteristics of one or more applications and/or one or more adapters; a computing component for computing a configuration change based on the monitored performance and workload characteristics; a change component for changing the configuration of the one or more adapters in accordance with the computed configuration change; and a change component for changing the configuration of the one or more applications in accordance with the computed configuration change.

### RELATED APPLICATIONS

This application claims priority to European Patent Application No. 10192196.3 filed on Nov. 23, 2010 and entitled SYSTEM AND METHOD FOR WORKLOAD MANAGEMENT IN A HETEROGENEOUS ENVIRONMENT, DATA PROCESSING PROGRAM, AND COMPUTER PROGRAM PRODUCT.

### BACKGROUND OF THE INVENTION

An enterprise service bus (ESB) is a software architecture model used for designing and implementing the interaction and communication between mutually interacting entities in a service-oriented architecture (SOA). Such an enterprise service bus (ESB) may provide a messaging infrastructure between IT systems, packaged applications from application vendors such as SAP, Siebel or Oracle (which typically require specialized software known as application connectors in order to be connected to the enterprise service bus (ESB)), custom-developed applications or software solutions such as WebSphere, e-commerce systems, human resource (HR) systems, and external participants connected to in-house application environments via business gateways to perform business-to-business (B2B) operations.

In such heterogeneous environments, there are often processes such as Opportunity to Order (OTO) processes running in customer relationship management (CRM) applications, Order to Cash (OTC) processes running in enterprise resource planning (ERP) applications such as SAP Netweaver ECC or Oracle Fulfilment Solutions to process the orders from a shipment and billing perspective, self-service customer channels that are based on e-commerce platforms where customers can place orders, and business-to-business (B2B) scenarios for supply delivery, business partner orders, etc. These represent just a few examples and are not intended to be limiting.

An end-to-end process from creating an opportunity to fulfilling a received order typically spans multiple systems—e.g., Siebel CRM and SAP Netweaver ECC comprising the previously mentioned OTO and OTC processes, WebSphere e-Commerce and Oracle Fulfillment, and business-to-business (B2B) business partner orders to SAP Netweaver ECC, where the enterprise service bus (ESB) is connecting all of these systems. For packaged applications, the “traffic” is either from the source application received through an application connector by the Enterprise Service Bus (ESB) or routed by the Enterprise Service Bus (ESB) through an application connector to the target.

Since one cannot predict if there will be a sudden increase, for example, of orders from an e-commerce platform or through business-to-business (B2B) interfaces (which could mean that the application connectors should receive more resources), it is unknown in advance if there will be changes in the workload that will require adjusting the resources of application connectors. It also cannot be predicted if business users working with a packaged application such as SAP will cause spikes in the workload.

Due to dynamic changes in the workload in complex environments, it is impossible to assign the right resources for application connectors at deployment time for the life cycle of the connectors being used. It is also impossible to assign the right resources within a packaged application for agents controlled by a workload manager component for inbound and outbound processing. It is also impossible to predict the workload for all possible combinations of applications which are loosely coupled. If either an application connector or a packaged application is not properly configured, there may be throughput and/or performance issues. The packaged application may respond too slowly to business user requests if the processing on the inbound/outbound interfaces takes too many resources.

Based on the scenarios described above, the load on application connectors is not predictable. Furthermore, the packaged application and application connector configuration is static, where changes to one side do not affect the other. The application connector is not aware of its resource consumption and thus is not reacting to it. The application connector also does not dynamically adjust packaged application configurations based on workload changes for inbound processing. Also the application connector does not self-adjust if the packaged application increases the workload pushed to the application connector for outbound processing.

The above-described issues cause throughput issues if the static configuration for one or more of the application connector and packaged application is wrong. The above-described issues also cause performance issues with the packaged application and application connector if too many resources are allocated to inbound/outbound processing and insufficient resources are allocated to business process processing. These issues may also cause inefficient use of resources within packaged applications and application connectors if settings for inbound/outbound processing are too high for average use, which decreases the resources available for business process processing. An administrator is typically not notified with regard to any of these issues or changes in workload.

In other cases, the configuration of a packaged application may be wrong as a result of inexperienced staff. If workload changes occur during non-business hours, staff may need to wait for normal business hours to make necessary configuration changes. The resulting delays or interruptions may leave business users unable to continue their work during non-business hours. Also, lack of support for cloud computing is an issue since application connectors do not offer an API to create, monitor, and enforce service level agreements (SLAs).

### SUMMARY

The invention has been developed in response to the present state of the art and, in particular, in response to the problems and needs in the art that have not yet been fully solved by currently available systems and methods. Accordingly, the invention has been developed to provide systems and methods to manage workloads in heterogeneous environments. The features and advantages of the invention will become more fully apparent from the following description and appended claims, or may be learned by practice of the invention as set forth hereinafter.

Consistent with the foregoing, a system for managing a workload in a heterogeneous environment comprising at least one application, an interoperability layer for inter-application communication, and at least one adapter for connecting the at least one application to the interoperability layer, is disclosed. Such a system includes a self-adapting application connector management component which includes the following: a monitoring component for monitoring the performance and workload characteristics of one or more applications and/or one or more adapters; a computing component for computing a configuration change based on the monitored performance and workload characteristics; a change component for changing the configuration of the one or more adapters in accordance with the computed configuration change; and a change component for changing the configuration of the one or more applications in accordance with the computed configuration change.

A corresponding computer-implemented method and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram showing one example of a heterogeneous environment;

FIG. 2 is a more detailed block diagram of the heterogeneous environment of FIG. 1; and

FIG. 3 is a flow diagram showing one embodiment of a method for managing a workload in a heterogeneous environment.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with an instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, may be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks. The computer program instructions may also potentially be distributed across multiple computers or programmable data processing apparatus for execution thereon.

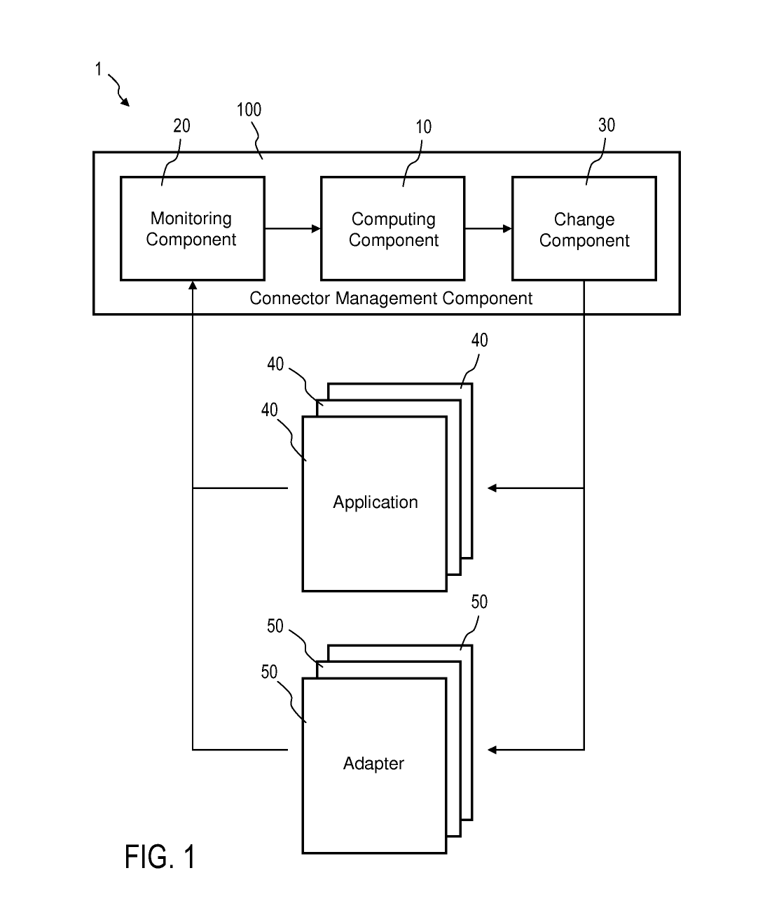

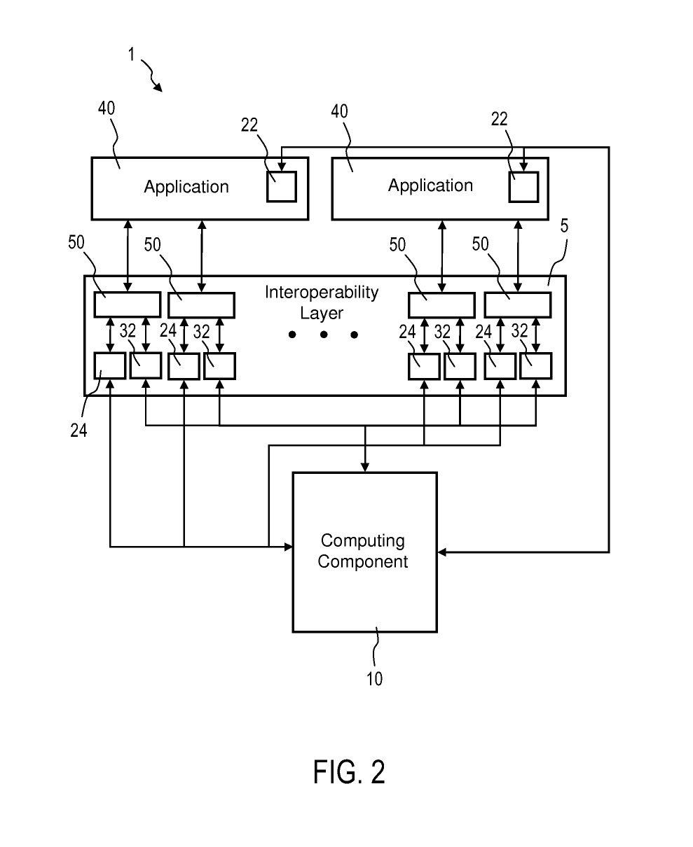

Referring to FIG. 1, the illustrated embodiment of the invention employs a system for workload management in a heterogeneous environment 1, which comprises at least one application 40, and at least one adapter 50 for connecting the at least one application 40 to an interoperability layer 5 shown in FIG. 2 for inter-application communication. The system is characterized by at least one self-adapting application connector management component 100 also called an enterprise application connection manager (EACM) which includes a monitoring component 20 for monitoring the performance and/or workload characteristics of the at least one application 40 and/or the at least one adapter 50, a computing component 10 for computing a self-adapting configuration change based on the monitoring, and change component 30 for changing the configuration of the at least one application 40 and/or the at least one adapter 50 according to the computed configuration. The self-adapting application connector management component 100 also includes a component 20 for reading at least one service level agreement (SLA), and a component 10 for checking compliance with the at least one service level agreement (SLA) based on the monitoring.

The performance and workload characteristics may comprise information about service level agreement (SLA) characteristics, available hardware and/or configuration of the at least one application 40 and/or the at least on adapter 50, and/or resources consumed by the at least one application 40 and/or the at least one adapter 50. Advantageously the computing component 10 computes the self-adapting configuration change dynamically to adapt to changes or non-compliance with resource consumption, workload, and service level agreements (SLAs). The self-adapting configuration changes may include adapter changes and/or application changes.

In the illustrated embodiment, the change component 30 for changing the configuration of the at least one application 40 and/or the at least one adapter 50 include at least one application programming interface (API) for changing the corresponding configuration.

Referring to FIG. 2, the illustrated embodiment of the invention employs a system for workload management in a heterogeneous environment 1, which comprises two applications 40, an interoperability layer 5 for inter-application communication, and four adapters 50 for connecting the applications 40 to the interoperability layer 5. The system is characterized by a self-adapting application connector management component 100 which includes components 22, 24 for monitoring the performance and/or workload characteristics of the applications 40 and the adapters 50, a component 10 for computing a self-adapting configuration change based on the monitoring, components 32 for changing the configuration of the adapters 50 according to the computed configuration change, and components 50 for changing the configuration of the applications 40 according to the computed configuration change.

The monitoring component 22 include at least one monitoring service 22 located at the applications 40 for monitoring the consumption of hardware resources and the performance of the corresponding application 40 by way of at least one application programming interface (API) provided by the at least one application 40. The monitoring component 24 includes at least one performance monitoring infrastructure 24 located at the adaptors 50 and controlled by the computing component 10.

The illustrated embodiment is presented only by way of example and not limitation. Different architectures and configurations are possible and within the scope of the invention. In certain embodiments, the packaged applications 40 are SAP Netweaver ECC applications, for example. In such embodiments, for each packaged application 40, a monitor service 22 may be provided which monitors the consumption of hardware resources such as CPU, memory, disk, and network resources using operating-system-level means (e.g., vmstat on AIX), and monitors the packaged application 40 through application programming interfaces (APIs) provided by SAP. The monitor service instances 22 communicate with the computing component 10. The system comprises 1 to m instances of application connectors per packaged application instance 40.

In the above-described example, there are two instances of a WebSphere adapter 50 for SAP for each SAP Netweaver ECC instance 40. Each instance of the WebSphere adapter 50 for SAP is performance monitored with respect to J2EE resources by a performance monitoring infrastructure (PMI) service 24. The performance monitoring infrastructure (PMI) service instances 24 are controlled by a deployment manager with a PMX connector (not shown). Through a PMX client (not shown) connected to the deployment manager with the PMX connector, the computing component 10 is able to communicate with all PMI services 24.

It is important to note that the WebSphere adapter 50 for SAP is used to reconfigure SAP through appropriate BAPI calls or through appropriate calls of custom ABAP function modules which are remote-function-call-enabled. Each instance of the WebSphere adapter 50 for SAP can share the WebSphere Enterprise Service Bus (WESB) runtime or be deployed on its own WebSphere Application Server (WAS) runtime. Each instance of the WebSphere adapter 50 for SAP is also controlled by a monitor and configuration service 32 which monitors the consumption of hardware resources such as CPU, memory, disk, and network resources using OS level means (e.g. vmstat on AIX) of the corresponding WebSphere adapter 50 for SAP. Each instance of the WebSphere adapter 50 for SAP can have its own hardware configuration.

The monitor and configuration service 32 may adjust certain parameters of the WebSphere adapter 50 for SAP programmatically to tune and reconfigure it as needed, and can terminate and restart the WebSphere adapter 50 for SAP with a different set of Java Virtual Machine (JVM) settings if needed. For example, a parameter for the maximum heap size for a JVM is statically set at startup time and cannot be changed at runtime. If for performance reasons the WebSphere adapter 50 for SAP requires more memory, the JVM will need to be re-launched to change the maximum heap size. One possible implementation technique is to deploy a new instance of the WebSphere adapter 50 for SAP with the appropriate settings. Once the new instance is up, the old instance that is too small may be shutdown. This allows instances of the WebSphere adapter 50 for SAP to be moved dynamically from one hardware instance to another as long as the monitor and configuration service 32 is available on the new hardware instance. Each instance of the monitor and configuration service 32 is controlled by the computing component 10.

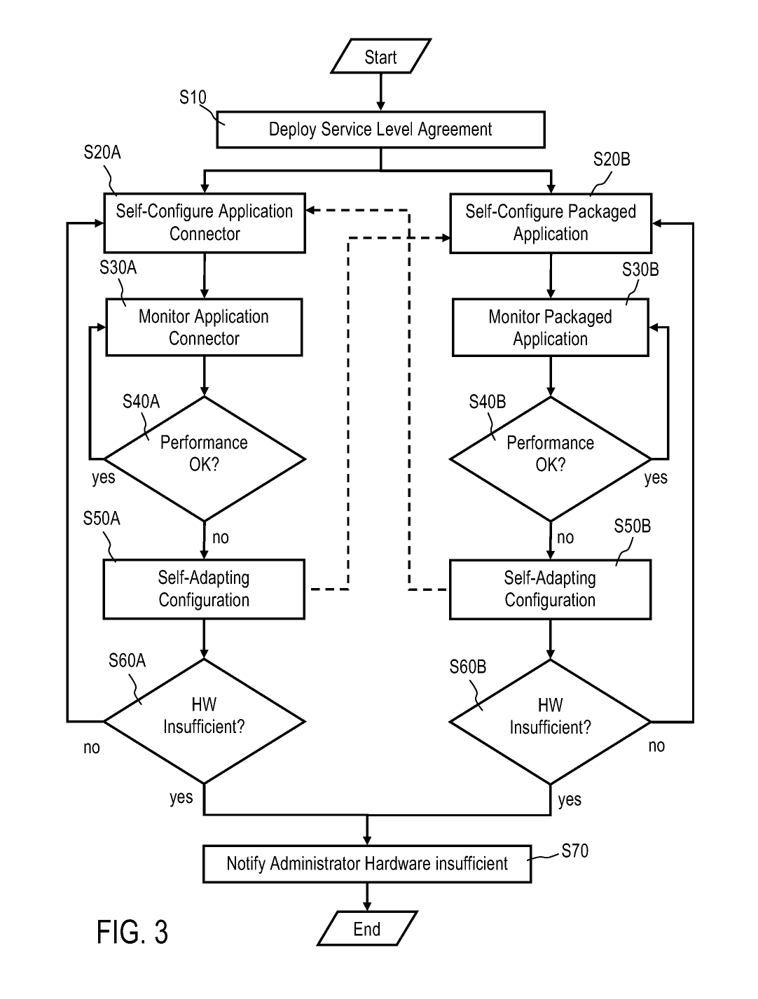

At the computing component 10, which ties everything together, a control flow (which will be explained in more detail in association with FIG. 3) is executed that provides ongoing performance monitoring on the application connector 50, packaged application 40, and OS levels; a prediction algorithm to determine future configurations based on changes in workload, known scheduled workloads in packaged applications, etc.; ongoing self-adaption of the configuration of the application connector 50 and the packaged application 40 due to changes in workload; and notification to administrators.

The computing component 10 also provides an application programming interface (API) supporting platform as a service by enabling service level agreement (SLA) based application connector deployment, where the service level agreement (SLA) can be for a group of related packaged applications 40 and their corresponding application connectors 50, or individually per packaged application 40 and its corresponding application connectors 50. A packaged application 40 may have logical groupings (in SAP terms “clients”) where 1 to n application connector instances 50 may be required for each logical group on initial configuration of the landscape.

In the illustrated embodiment, one self-adapting application connector management component 100 is used for the entire landscape supporting all applications 40 and corresponding application adapters 50. Alternatively, in other embodiments (not shown), one self-adapting application connector management component 100 may be used per pair of applications 40 and corresponding application adapters 50 in an end-to-end landscape. In either case, the intent is to provide a self-adapting infrastructure for application connectors so that both cases are covered.

Referring to FIG. 3, a method for managing a workload in a heterogeneous environment 1, which includes at least one application 40, an interoperability layer 5 for inter-application communication, and at least one adapter 50 for connecting the at least one application 40 to the interoperability layer 5, is illustrated. The method uses at least one self-adapting application connector management component 100 to monitor performance and/or workload characteristics of the at least one application 40 and/or the at least one adapter 50, and compute a self-adapting configuration change based on the monitoring, wherein the self-adapting configuration change includes changing the configuration of the at least one application 40 and/or the at least one adapter 50 according to the computed configuration change. The self-adapting application connector management component 100 reads at least one service level agreement (SLA), and monitors compliance with the at least one service level agreement (SLA).

The configuration of the at least one application 40 and the at least one adapter 50 is changed dynamically to adapt to changes to or non-compliance with resource consumption, workload, and service level agreements (SLA). This is accomplished, at least partly, by monitoring performance and workload characteristics of the at least one application 40 and the at least one adapter 50. The performance and workload characteristics may include service level agreement (SLA) characteristics, available hardware and/or configuration of the at least one application 40 and/or the at least on adapter 50, and/or resources consumed by the at least one application 40 and/or the at least one adapter 50.

The monitoring is performed by at least one monitoring service 22 located at the at least one application 40. The monitoring service 22 monitors consumption of hardware resources and performance of the at least one application 40 using an application programming interface (API) provided by the at least one application 40. Monitoring is also performed by at least one performance monitoring infrastructure 24 located at the at least one adaptor 50 and controlled by the self-adapting application connector management component 100.

Now the method for managing workload in a heterogeneous environment 1 is discussed in the context of the WebSphere adapters 50 for SAP and the SAP Netweaver ECC 40. It is assumed that the installation of the enterprise application connection manager 100 is complete which means that all hardware with key characteristics available for instances of application connectors 50 is known by the enterprise application connector. On each hardware instance 50, the monitor and configuration service 32 is deployed as well as the runtime for the application connector 50. This may include an instance of WAS or WESB since these are two possible runtimes for the WebSphere adapter 50 for SAP. The packaged application 40 is installed and ready to use and a monitor service 22 for the packaged application 40 has been deployed. This would mean that SAP Netweaver ECC 40 is installed and ready to use and a monitor service 22 has been configured for the SAP Netweaver ECC system to collect the relevant performance information and communicate with the computing component 10.

When these prerequisites are fulfilled, for a new packaged application 40, a service level agreement (SLA) for the application connector 50 is created S10 using a user interface of the application connector management component 100. The service level agreement (SLA) contains information about the interfaces the application connector 50 must support (e.g. IDOC, IDOC message types, inbound or outbound or both, which SAP client, etc.), and expected throughput and performance requirements.

At steps S20A and S20B, the application connector management component 100 processes the service level agreement (SLA) and determines the required configuration for the packaged application 40 (SAP Netweaver ECC) and the application connector 50 (WebSphere Adapter for SAP). The required configuration is split into an application connector 50 (WebSphere adapter for SAP) specific part (A) and a packaged application 40 (SAP Netweaver ECC) specific part (B).

The application connector (WebSphere adapter for SAP) specific part (A) requires, in step S20A, to launch the application connector 50 in its runtime with appropriate configuration such as JVM settings on the appropriate and free hardware determined by examining the configuration of the application connector management component 100. The packaged application (SAP Netweaver ECC) specific part (B) is configured programmatically in step S20B using appropriate APIs. For the WebSphere adapter for SAP, the performance monitoring infrastructure (PMI) service 24 is launched and connected through the previously described infrastructure to the computing component 10 in step S20A.

In general, the programmatic self-configuration may occur in parallel as shown in FIG. 3. However, in the case of a SAP Netweaver ECC system and the WebSphere adapters for SAP, this initial deployment of the configuration based on the Service Level Agreement (SLA) would happen sequentially since the programmatic access to a SAP system would only be available through the WebSphere adapters for SAP using the BAPI interface or custom ABAP function modules that are RFC-enabled. After initial deployment, the configurations may be managed independently from one another, such as if there is a need to adjust the SAP configuration but not the configuration of the WebSphere adapter for SAP.

Once the initial configuration is deployed, the application connector management component 100 triggers the appropriate performance monitoring in steps S30A step S30B. For the application connector 50 (WebSphere adapter for SAP), this consists of triggering the performance monitoring infrastructure (PMI) service 24 at step S30A to capture statistics on JCA Connections and monitor CPU, memory, disk, and network resources by leveraging OS capabilities of the monitor and configuration service 32. For the packaged application 40 (SAP Netweaver ECC), the application connector management component 100 triggers the monitor service 22 at step S30B. This monitor service 22 captures SAP workload characteristics and monitors CPU, memory, disk, and network resources by leveraging OS capabilities. After the initial deployment is complete and the performance monitoring is started, self-adapting inner loops make sure that the configuration is continuously adapting to changing workloads.

At regular intervals as indicated by the service level agreement (SLA), the performance and throughput is measured and compared against the performance and throughput required by the service level agreement (SLA). For the application connector 50 (WebSphere adapter for SAP) this comparison occurs at step S40A and may result in several outcomes. If the measurements are within the acceptable range and no scheduled tasks in the packaged application 40 (SAP Netweaver ECC) require configuration changes, the monitoring continues at step S30A without making any changes to the configuration. If, on the other hand, the measurements are outside of the acceptable range and/or there are scheduled tasks in the packaged application 40 (SAP Netweaver ECC) requiring configuration changes, self-adapting configuration processing is started at step S50A.

To determine the required changes to the configuration, a prediction algorithm may consider, for example, service level agreement (SLA) requirements, estimated impact on performance/throughout by scheduled tasks if applicable, performance history (Patterns determined by JCA connection usage based on performance monitoring infrastructure (PMI) service monitoring can indicate, for example, how much additional resources might be feasible to allocate if more resources are required), the available average free hardware resources where the application connector instances 50 (WebSphere Adapter for SAP) and the packaged application 40 (SAP Netweaver ECC) is running (here, measurements of the CPU, memory, disk, and network resource consumption may be used), the available free hardware (based on the configuration maintained by the enterprise application connection manager 100).

Based on considering a number of these characteristics, the prediction algorithm of the application connector management component 100 has two possible outcomes at step S60A:

First, given the current available hardware, the current/upcoming workload cannot be handled by any configuration with the available hardware. In such a case, the administrator could be notified at step S70 by means such as SMS, email, etc., depending on the implementation. The “Exit” block in FIG. 3 following step S70 indicates that, until additional hardware is added to the system or the workload is reduced, the overall infrastructure will not be able to satisfy the demands of the service level agreement (SLA).

Second, using the available hardware resources, there is a configuration change that is possible to ensure that the overall infrastructure continues to run in compliance with the service level agreement (SLA). In this case, the prediction algorithm of the application connector management component 100 returns the change computed at step S50A and triggers the configuration change at step S20A by issuing appropriate commands to the self-configure application connector module. Such configuration changes may include launching another instance of the application connector 50 (WebSphere adapter for SAP) with more heap size for the JVM and terminating the current instance or changes to the JCA connection configuration in a given application connector 50 (WebSphere adapter for SAP) instance. As indicated by the dashed line in FIG. 3, in addition to changing the application connector 50 (WebSphere adapter for SAP), applicable and aligned changes on the packaged application 40 (SAP Netweaver ECC) may be triggered at step S20B. An example for a SAP Netweaver ECC system might be the creation of an additional RFC destination for an increase in parallel processing.

For the packaged application 40 (SAP Netweaver ECC), the current performance and throughput are compared with the service level agreement (SLA) at step S40B. Conceptually, the flow here follows the same pattern as for the application connector 50. If the performance and throughput are satisfactory and no upcoming scheduled tasks require a change, monitoring continues at step S30B and there is no change in configuration. If the performance and/or throughput are not satisfactory and/or upcoming scheduled tasks require a change, self-adaption configuration processing is triggered at step S50B which uses the prediction algorithm of step S60B and conceptually similar parameters as previously discussed to lead to two possible outcomes:

First, given the current available hardware, no configuration change is possible that can satisfy the workload within the constraints of the given hardware. In such a case, the administrator is notified at step S70 and the same conclusions are reached as previously outlined for the application connector 50.

Second, there is a configuration change possible that will allow the packaged application 40 to continue to comply with the service level agreement (SLA). In this case, the application connector management component 100 issues the appropriate configuration changes to the self-configure packaged application module at step S20B. An example of such a configuration change could be for a SAP Netweaver ECC system to assign more or fewer agents in the workload manager to the task of IDOC inbound/outbound processing as determined by the prediction algorithm. As indicated by the dashed line, applicable and aligned changes may also be made on the application connector 50 (WebSphere adapter for SAP). These changes may be routed to the self-configure application connector module at step S20A. An example of such changes could be to create additional instances of the WebSphere adapter for SAP to exploit the RFC destinations which have been created on SAP for improved parallel processing.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in a block may occur out of the order noted in the Figures. For example, two blocks shown in succession may, in fact, be executed substantially concurrently, or the blocks may sometimes be executed in the reverse order, depending upon the functionality involved. Some blocks may be deleted or other blocks may be added depending on the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A computer-implemented method for managing a workload in a heterogeneous environment, the heterogeneous environment comprising at least one application, an interoperability layer for inter-application communication, at least one adapter for connecting the at least one application to the interoperability layer, the computer-implemented method comprising:
monitoring the performance and workload characteristics of at least one of the following: (1) at least one application; and (2) at least one adapter;
computing a configuration change based on the monitored performance and workload characteristics;
changing the configuration of the at least one adapter in accordance with the computed configuration change; and
changing the configuration of the at least one application in accordance with the computed configuration change.

2. The computer-implemented method of claim 1, further comprising:
reading at least one service level agreement (SLA); and
monitoring compliance with the at least one service level agreement (SLA).

3. The computer-implemented method of claim 1, wherein the performance and workload characteristics comprise at least one of the following: service level agreement (SLA) characteristics, available hardware, configuration of the at least one application and the at least one adapter, and resources consumed by the at least one application and the at least one adapter.

4. The computer-implemented method of claim 1, wherein computing the configuration change comprises computing the configuration change dynamically to adapt to at least one of changes in resource consumption, changes to workload, and non-compliance with service level agreements (SLAs).

5. The computer-implemented method of claim 1, wherein the configuration change comprises at least one of an adapter configuration change and an application configuration change.

6. The computer-implemented method of claim 1, wherein changing the configuration of the at least one adapter and changing the configuration of the at least one application each comprise changing the configuration by way of an application programming interface (API).

7. The computer-implemented method of claim 1, wherein monitoring the performance and workload characteristics comprises using a monitoring service, located at the at least one application, to monitor the consumption of hardware resources and the performance of the at least one application.

8. The computer-implemented method of claim 1, wherein monitoring the performance and workload characteristics comprises using at least one performance monitoring infrastructure located at the at least one adapter and controlled by the computing component.
